(19) United States
(12) Patent Application Publication
(10) Pub. No.: US 2012/0191543 A1
(43) Pub. Date: Jul. 26, 2012

(54) Generation and Viral Distribution of Geo-Location Specific Content on Mobile Handheld Display Devices Via the Internet and Social Media

(76) Inventor: Srinivasa DHARMAJI, Cupertino, CA (US)

(21) Appl. No.: 13/437,825

(22) Filed: Apr. 2, 2012

Related U.S. Application Data
(63) Continuation-in-part of application No. 13/078,638, filed on Apr. 1, 2011.
Application No. 13/078,638 is a continuation-in-part of application No. 13/078,297, filed on Apr. 1, 2011.
Application No. 13/078,297 is a continuation-in-part of application No. 12/368,141, filed on Feb. 9, 2009.
(60) Provisional application No. 61/065,258, filed on Feb. 11, 2008.

(51) Int. Cl. G06Q 30/02

(52) U.S. Cl. 705/14.58

(57) ABSTRACT

Relevant dynamic interactive advertisements and alternate content are presented to users for viewing on wireless mobile handheld display devices (MHDDs) via mobile applications and browsers. Compiled location- and store-specific, customized dynamic and interactive advertisements are delivered as a mobile display advertisements or adsites to each user. The user receives a rolling advertisement with an adsite per side of the roller. Upon user interaction with any adsite, a compiled microsite of components of the adsite and dynamic components is displayed on the display screen for response and feedback by the user. The adsite is saved and shared as a link over the Internet and via social media. Any new user, receiving and activating the link, is connected to an ad serving unit and is provided with a user- and location-specific adsite.

### CROSS REFERENCE TO RELATED APPLICATIONS

This application is a continuation-in-part of U.S. patent application Ser. No. 13/078,638 (attorney docket no. GLDS0024) filed Apr. 1, 2011, Method For Maximizing Brand Exposure In Minimal Mobile Display, which application claims priority to Ser. No. 13/078,297 (attorney docket no. GLDS0023), filed Apr. 1, 2011, Hot-Spot Use in Advertisement, which application claims priority to U.S. patent application Ser. No. 12/368,141 (attorney docket no. GLDS0013), filed Feb. 9, 2009, End-To-End Response Enabling Collection and Use Of Customer Viewing Preference Statistics, which application claims priority to U.S. provisional patent application Ser. No. 61/065,258, filed Feb. 15, 2008, End-To-End Response Enabling Collection and Use Of Customer Viewing Preference Statistics; each of which is incorporated herein in its entirety by this reference thereto.

### BACKGROUND OF THE INVENTION

1. Technical Field

This invention relates to the display of dynamic interactive advertisements and alternate content on wireless enabled mobile handheld display devices (MHDDs) during user viewing of content on such devices. More specifically, the invention relates to the delivery of generated location-specific, dynamic and interactive mobile display advertisements to the user with capability for client specific involvement in distribution, response, and feedback.

2. Description of the Background Art

The use of mobile handheld display devices (MHDDs) has been increasing very fast as MHDDs have grown in processing power and storage and display capabilities. Such devices are now commonly used for viewing of content that is delivered over the available wireless connectivity. Selective delivery of focused advertisements (ads) to different target groups of mobile content viewers has become an essential component of product and service advertising. Such mobile viewer groups (MVGs) are becoming increasingly important and valuable to advertisers as the numbers of such groups continue to increase.

There is limited capability of delivering customer and/or group specific ads using specific preferred ad interaction methods to target MVGs today. The ads and the content thereof must be delivered to the MHDDs of target MVGs. Responses to such ads are collected back using an interactive call-to-action enabler, such as switches or inserts instantiated on the display of the MHDDs, all using the processing power of the MHDDs. Compiling these ads with dynamic and static content, and delivering these ads to specific MVGs using location based service (LBS), is a major expense in providing such focused dynamic content to users. Because methods for delivery of these complex ads are still not optimized for the small MHDD screens and limited storage capabilities of the MHDDs, it has been difficult to implement delivery of LBS ads to the right consumers in the correct locations.

Generating these LBS ads has been an expensive and time consuming operation. If the ads can be generated and configured for specific locations and customer preferences to provide coverage for LBS areas, it will facilitate and improve the return on investment of the LBS ads developed for an ad campaign. If delivery and display of the generated ads can be tied into location identification capability in the new MHDDs and the processing power of the MHDDs to select and display the components of the ad specific to a location it will be of further advantage to the campaign.

Because the ads are becoming more complex with multiple messages, it is necessary to present such ads in full or in a repetitive fashion on the MHDD to achieve full impact. This makes the typical single banner space display insufficient for such displays. Part, or even all, of the display space is necessary to get the full impact of each ad, but the user often dislikes such a display because it intrudes on his viewing time during multimedia content consumption.

Today ads are provided and distributed based on the campaign decisions. The consumer or user has no input or part in the distribution of ads. The delivery and display of the ads is the prerogative and function of the company responsible for the campaign. If a user likes an ad, the user's input in furthering the product advertised is limited in nature to word of mouth. There is, today, no capability provided to the user to save or distribute ads that the user likes, to other users. Providing such a feature would be of great advantage to the advertiser.

It is therefore, advantageous to use the location identifying capability and the processing capability of the MHDD system to choose and display the right LBS ads to the consumers at any selected location. It will be of further advantage if such a system of ad delivery can be developed to cover multiple locations with ads for a product or service as the MHDD moves through the locations. It is further advantageous if ads can be shown in full within the banner space available, while providing the capability to the user to respond to any portion of the ad that is being viewed as the user is consuming multimedia content on the MHDD. It will be further advantageous if the user is able to save the ad and distribute it over Internet and social media to friends, family, and other contacts for their consumption.

### SUMMARY OF THE INVENTION

To address the above mentioned shortcomings of state of the art advertising approaches, relevant dynamic interactive advertisements and alternate content are presented to users for viewing on wireless mobile handheld display devices (MHDDs) via mobile applications and browsers. Compiled location- and store-specific, customized dynamic and interactive advertisements are delivered as a mobile display advertisements or adsites to each user. The user receives a rolling advertisement with an adsite per side of the roller. Upon user interaction with any adsite, a compiled microsite of components of the adsite and dynamic components is displayed on the display screen for response and feedback by the user. The adsite is saved and shared as a link over the Internet and via social media. Any new user, receiving and activating the link, is connected to an ad serving unit and is provided with a user- and location-specific adsite.

### BRIEF DESCRIPTION OF THE DRAWINGS

FIG. 1 is a schematic representation of the capabilities of a multi-channel marketing architecture according to the invention;

FIG. 2 is a screen-shot showing generated ad components suitable for multiple locations according to the invention;

FIG. 3 is a series of screen shots for three locations, i.e. San Francisco, New York, and Dallas, showing a group of dynamic components, such as pictures specific to each location that can be viewed by interacting with an adsite presented according to the invention;

FIG. 4 is a series of screen shots for three locations, i.e. San Francisco, New York, and Dallas, showing a group of dynamic location specific video components, such as video relating to an ad which can be viewed by interacting with an adsite that displays a video icon when it is displayed in the banner area according to the invention;

FIG. 5 is a series of screen shots for three locations, i.e. San Francisco, New York, and Dallas, showing a group of dynamic location specific coupons presented within the adsite for the use of the customers or users according to the invention;

FIG. 6 is a series of screen shots for three locations, i.e. San Francisco, New York, and Dallas, showing a group of dynamic location specific inputs for a request for a quote for a product according to the invention;

FIG. 7 is a screen shot showing a microsite that is generated and displayed on an MHDD upon user interaction with an adsite shown in the banner area on the MHDD in San Francisco, and in which the microsite can be saved and a link established which can be sent to friends and family, according to the invention;

FIG. 8 is a flow diagram showing ad distribution followed by microsite generation and sharing of the microsite with friend and family contacts of the user according to the invention;

FIG. 9 is a flow diagram showing access, use, and distribution of location based promotional material by the user according to the invention;

FIG. 10 is a flow diagram showing transfer of microsite and promotional material by the user to friends and family and their access and use of the same during shopping according to the invention; and

FIG. 11 is a block schematic diagram of a machine in the exemplary form of a computer system within which a set of instructions for causing the machine to perform any of the herein disclosed methodologies may be executed.

### DETAILED DESCRIPTION OF THE INVENTION

Embodiments of the invention enable the presentation of full dynamic interactive advertisements and alternate content on wireless enabled mobile handheld display devices (MHDDs) during viewing of video and other dynamic content by a user of the device. Embodiments of the invention deliver location specific, dynamic and interactive service advertisements (ads) as a group of advertisement sites (adsites) to the user with the capability for client-specific and location-specific ad compilation and with the capability for response and feedback. In addition, a compiled ad can be saved as a microsite of component adsites for sharing of the ad over the Internet and social networks by the user. By enabling a link from the new user receiving the microsite to the ad serving unit, the new user is also provided with user-specific and location-specific adsites to increase the impact of good ads and maximize return on investment.

An apparatus and method for the presentation of dynamic interactive advertisements and alternate content for viewing on wireless enabled mobile handheld display devices (MHDDs) during viewing of content is thus disclosed. More specifically, embodiments of the invention disclose the dynamic assembly of interactive advertisements to generate automatically a mobile optimized, and search engine optimization enabled, mobile microsite, along with a mobile display ad, based on dynamic targeting data such as geo-location, store location, user preferences, etc. The mobile display ad is presented to the user in the available banner area or full screen of the MHDD and can be shared with friends and family via viral mechanisms, such as email, SMS, Facebook®, Twitter®, Google+®, and others for maximum brand exposure.

As with websites that display publisher content to a user as Web pages via the user's browser, mobile advertisement Sites (adsites) are home to the advertiser's geo-targeted content for MHDDs. Adsites can contain all types of multimedia content presented to the user in a ways that are similar to websites and also in ways that are dissimilar (see, for example, U.S. patent application Ser. No. 13/078,638 (attorney docket no. GLDS0024) filed Apr. 1, 2011, Method For Maximizing Brand Exposure In Minimal Mobile Display; Ser. No. 13/078,297 (attorney docket no. GLDS0023), filed Apr. 1, 2011, Hot-Spot Use in Advertisement; U.S. patent application Ser. No. 12/368,141 (attorney docket no. GLDS0013), filed Feb. 9, 2009, End-To-End Response Enabling Collection and Use Of Customer Viewing Preference Statistics; and U.S. provisional patent application Ser. No. 61/065,258, filed Feb. 15, 2008, End-To-End Response Enabling Collection and Use Of Customer Viewing Preference Statistics; each of which is incorporated herein in its entirety by this reference thereto).

Embodiments of the invention use adsites intelligently to present an ad on a MHDD in a way that redefines the ad and ensures that the user is kept engaged, for example by conquering banner blindness. Thus, brand exposure is maximized and a geo-targeted microsite is automatically created that can be sent as a URL over email and social networks to enhance the ad impact during the ad campaign and beyond.

According to an embodiment, an ad comprises a basic framework that is defined by the ad campaign. The basic frame work comprises all of the common ad components assembled within the ad, and makes specific provision for dynamically retrieving components that cover specific locations as adsites. The location-specific components of the ad for each of the different locations are included as part of the ad supplied to the MHDDs. MHDDs are normally able to recognize their current location at any instant by using built in capabilities, such as global positioning system (GPS) indications, or by triangulation using transmission towers or by IP address lookups. The ad displayed as adsites are then configured on the MHDD to be location specific, thus providing promotions, coupons, and incentives by selecting the correct components from the available components using the processing capability of the MHDD.

Typically, the main adsite components are configured and presented to the user during viewing of content by the user by using the rendering and display capability of the MHDD within the banner area of the MHDD. Where multiple adsites are part of the campaign the main component of each adsite can be compiled and presented as a side of a rotating or rolling ad in the banner area of the MHDD. Each adsite presented may or may not contain links to other adsites in the basic ad framework. If the user shows interest in the adsite, for example in the banner area by interacting with it by clicking within the banner area, a mobile web site or micro-ad (microsite) is dynamically configured and displayed on the MHDD screen. The microsite is generated on the MHDD from the components of the main ad and dynamic components, including locational and interactive components. The microsite can be configured to use either a part of, or all of, the MHDD display area as necessary to achieve maximum impact of the ad.

The user can also then choose to move to other adsites of the ad using interactive switches on the microsite, or the user save the micro-ad or microsite with a linkage to the original ad location on the ad server with all the product and location specific information. This microsite can be sent by the user to family, friends, and contacts over, for example, the Internet, short message service (SMS), Facebook®, Twitter®, or other communication capabilities of the MHDD.

The activation of the linkage to the microsite by a new user receiving a generic microsite URL, establishes a link between the new user and the original location of the ad enabling the adsites in the form of microsites to be presented to the new user with location specific components related to the new user within the ad framework. This linkage to friends and family allows generation of a larger database for ad distribution than possible with direct access alone. The location-specific ads are hence more effectively distributed to friends and family with all the coupons and promotion information for the specific location to make the ad campaign more effective in the local area.

If the user is part of an MVG travelling around different locations, the ads displayed on the MHDD are changed to suit the location where the MHDD is at the time. The user assisted distribution of the configured microsite is a method for wider effective distribution of the ad, providing effective coverage of local population that have an interest in the product and hence providing higher impact and response for the campaign.

The basic advertisement (ad) is displayed as a three dimensional rolling ad (3D roller), a three dimensional (3D) rotating ad (3D rotator), or other types of ad display in the designated banner area of the MHDD during initial display. The initial display is typically the main message of the ad as an adsite. If a user finds any of the adsites of interest as it is displayed, he has the option of interacting with the display in multiple ways, such hovering over the ad display area or the area of interest to open, or clicking on the adsite to expand to partial or full screen mode to display more ad elements.

In the typical case, the mode of operation preferred by the user is part of the preferred operation detail for the user stored on his MHDD, and is invoked as part of the adsite and microsite display. When there is interest shown by the user, the adsite for which user interest exists is configured as a microsite and displayed on the MHDD by any of the methods described in, for example, U.S. application Ser. No. 13/078,638 (attorney docket no. GLDS0024) filed Apr. 1, 2011, Method For Maximizing Brand Exposure In Minimal Mobile Display, such as unrolling the microsite, expanding the microsite to cover the necessary display area on the MHDD, etc.

When a microsite is displayed, the user can interact fully with the microsite shown. Each adsite, when displayed in the banner area or, when the configured microsite is displayed as a partial or full display consists of, for example, three distinct display and support areas within the display on MHDD, i.e. the banner or ad display area which is a part of the total display area of the MHDD, a navigation support area within the ad or microsite displayed, and an interactive save and share support area.

The banner area shows specific adsite blocks or segments of the ad. The banner area can be displayed anywhere within the MHDD display initially. The full adsite of the ad is displayed as a configured microsite on the MHDD in response to a user tap or other show of interest within the specified banner area that displays the ad.

The corresponding navigation bar in the navigation support area calls out the type of content and other adsites of the ad within the banner area. The navigation area helps the user to move between different types of content displays in the various adsites. Additional linked hotspots are used to move to linked sites in each of the Ad displays. The hotspots within the adsites allow the user to interact with the content displayed where necessary.

The interactive save or share support with an area lets users save the adsites as a microsite having a generic URL with all details and a link to the original ad location. The user can then send the saved microsite virtually through e-mail, SMS, Facebook®, Twitter®, or any other one-way or two-way communication protocol based application on the MHDD.

When a microsite is sent, the link is established to the original ad location, which allows the new user to be presented with a new location-specific microsite for display during opening of the link. Presentation of the microsite generated from the microsite link on the original user's MHDD typically comprise the location-specific ad components displayed as a new configured microsite with navigation areas for the other microsites of the ad. The microsites displayed are similar to the original microsite of the original user, but with new location-specific dynamic components included. The link also enables development of user opted-in customer relations (CRM) database with specific customer preferences for future use.

Another unaddressed issue in mobile advertising is the ability to present an ad to the user to let users save/share the ad and the location specific coupons and promotion distribution with their friends. The specific coupons are presented to the user or their friends based on various targeting criteria developed and made available with the ad campaign. This need also has been addressed by the herein disclosed adsites and the transferable microsite. By enabling location specific dynamic content in the displayed adsites and configured microsites, the available coupons or promotions are included into the generated microsites and the displayed adsites. These are served to the user via the navigation support within the adsites or microsites displayed. The user can then choose to use the coupons and promotions by linking to the main ad serving computer by accessing hotspots or links on the microsites and adsites. The linkage to the ad server and to the advertiser enables development of a location-specific customer preference database for every new customer who accesses the promotions as part of the CRM database.

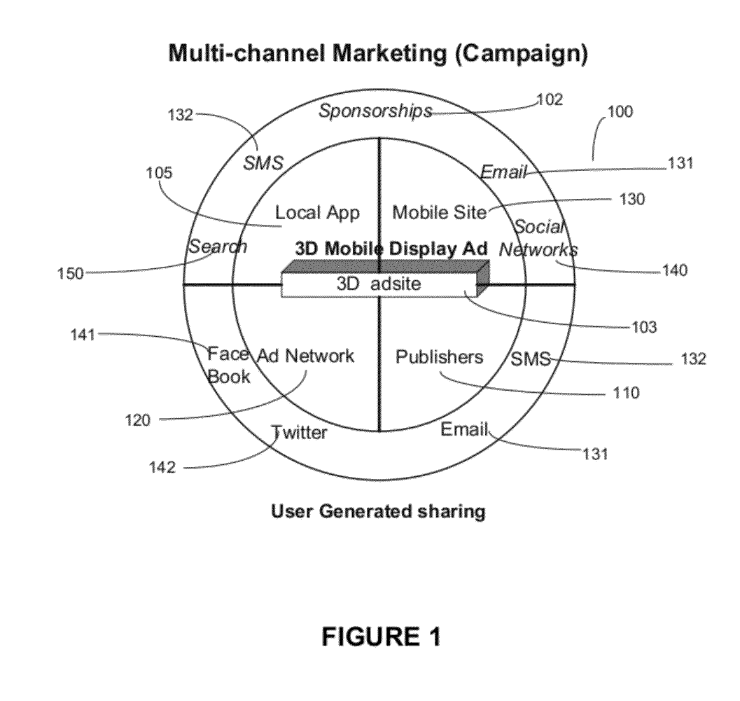

FIG. 1 is a schematic representation of the capabilities of a multi-channel marketing architecture according to the invention. The invention provides a new paradigm in mobile marketing. The herein disclosed adsite works with the retailer's overall mobile strategy in a seamless fashion, integrating CRM, social, and mobile national marketing and local marketing needs in a single solution. The solution generates a single ad tag for distribution across all publishers and ad networks. The local content, if it is to be added, is dynamically integrated in and delivered with each ad call and every microsite visit by use of the processing and location identifying power of the MHDD. Microsites are generated that link with the advertiser's corporate marketing initiative, while supporting national or local message delivery with a mobile optimized format.

A multi-channel marketing capability is shown in FIG. 1, 100 that supports sponsored campaigns 102 with local applications 105 included, displayed as adsites 103, typically in a 3D roller form. The adsites are optimized for distribution and display across publishers 110 and networks 120. The adsites can be converted to mobile sites (microsites) 130 with a URL link having static and localized dynamic content including the local aps 105. The microsites having a link enable the ad to be distributed over email 131, SMS 132, and other social media 140. The social media over which links can be distributed include Facebook® 141, Twitter® 142, Google+®, and others. Embodiments of the invention also provide the ability to search 150 within the microsite for specific items, and to move between adsites within the ad display using navigation bars. Sponsors and sponsorships are included and displayed as adsites and microsites within the ad.

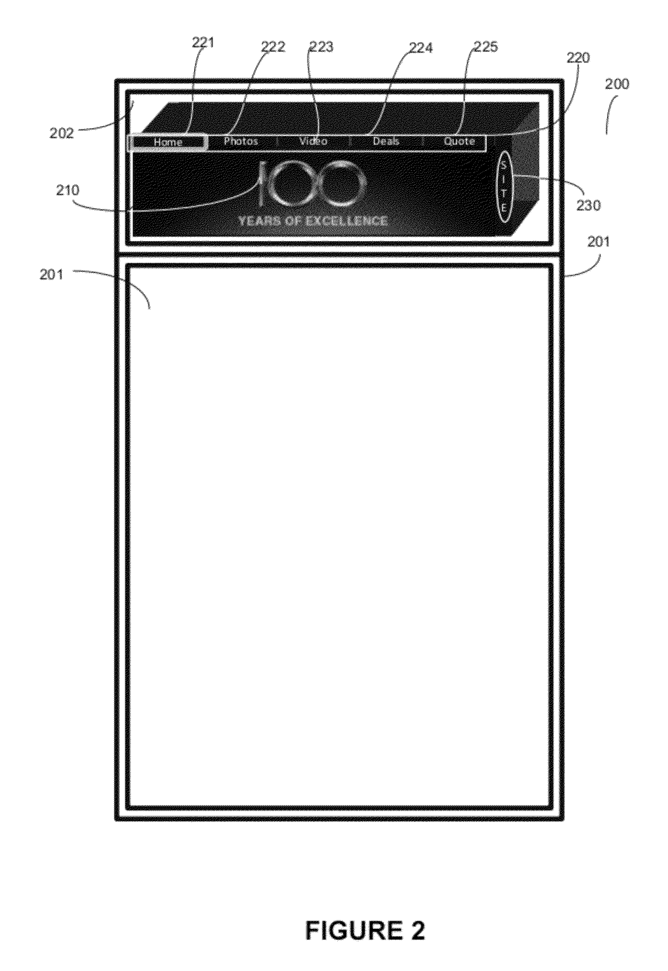

FIG. 2 is a screen-shot showing generated ad components suitable for multiple locations according to the invention. FIG. 2 shows the MHDD screen 200 during viewing of content in the viewing area of the screen 101 with main adsite 210 of a Chevrolet ad displayed to the customer on his MHDD in the banner display area 202. The main adsite in the banner area 202 shows the display region split into the main display of the ad campaign 210, the navigation bar on the display 220, and a save and forward location 230. The navigation bar in this case contains different tags for moving around to other adsites within the ad. The tags shown are Home 221, Photos 222, Video 223, Offers 224 and Quote 225.

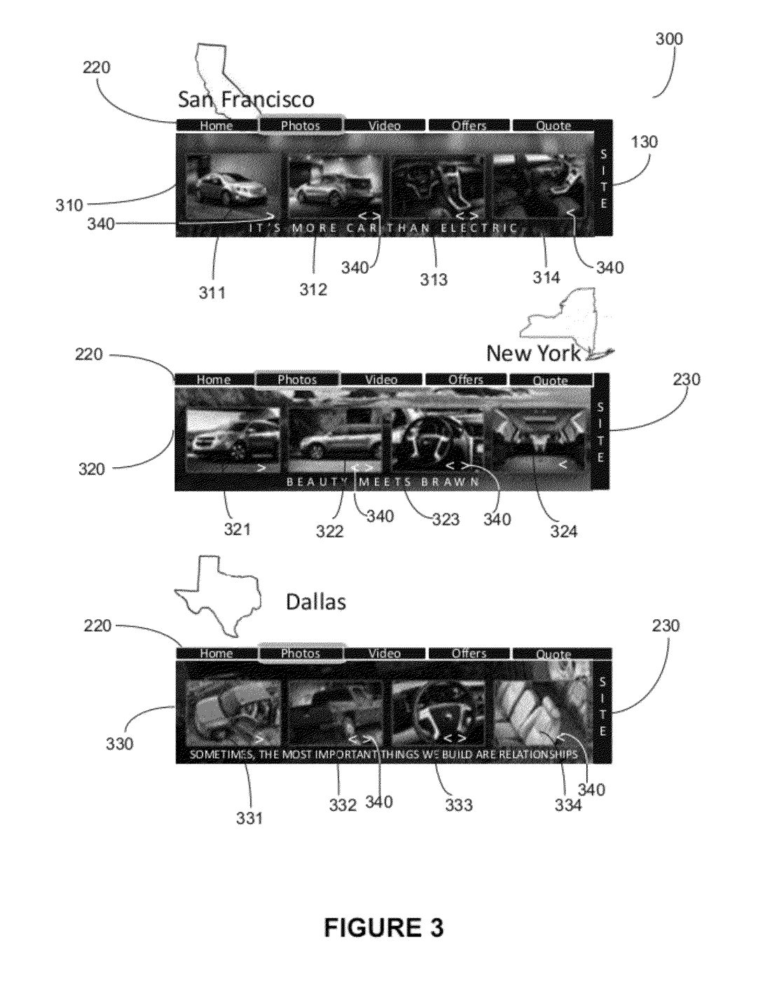

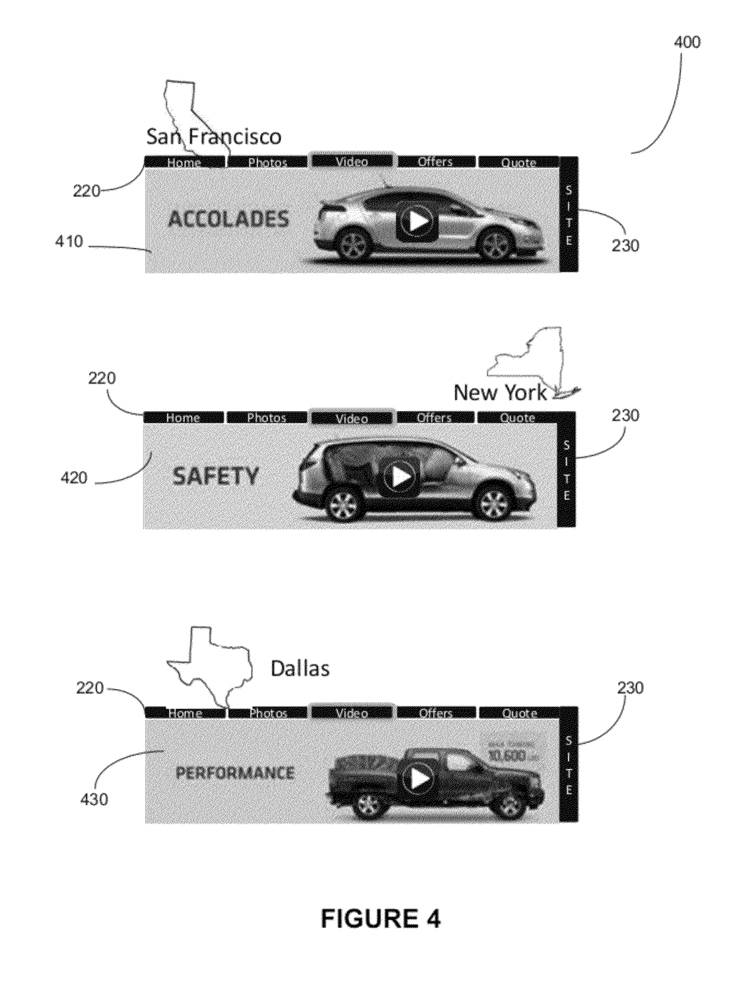

The ad itself is a 3D roller or a 3D rotator which continuously shows different adsites that relate to the location, such as the first picture 311, 321, or 331 shown in FIG. 3, or the start frame for video 410, 420 or 430 from FIG. 4 for a specific location, such as San Francisco, New York, or Dallas, respectively, in the banner area.

The customer can move between the adsites using the navigation bar shown, or engage with the adsite by clicking on the ad to view any of the additional existing adsites within the location specific dynamic unit of the adsite. The save and forward region in the banner areas has a tag designated site 230 which allows formation of a microsite and forwarding of the same to family and friends as described earlier.

FIG. 3 is a series of screen shots for three locations, i.e. San Francisco, New York, and Dallas, showing a group of dynamic components, such as pictures specific to each location that can be viewed by interacting with an adsite presented according to the invention. FIG. 3 shows a first set of location specific group of components 300, such as pictures, for three designated marketing areas (DMA) or locations, e.g. San Francisco, Calif. 310, having pictures 311 to 314; New York, N.Y. 320, having pictures 321 to 324; and Dallas, Tex. 330, having pictures 331 to 334. Each of these groups has additional hotspots 340 to move between the pictures.

FIG. 4 is a series of screen shots for three locations, i.e. San Francisco, New York, and Dallas, showing a group of dynamic location specific video components, such as video relating to an ad which can be viewed by interacting with an adsite that displays a video icon when it is displayed in the banner area according to the invention. FIG. 4 shows video components 400 for the three locations 410 for San Francisco, 420 for New York, and 430 for Dallas.

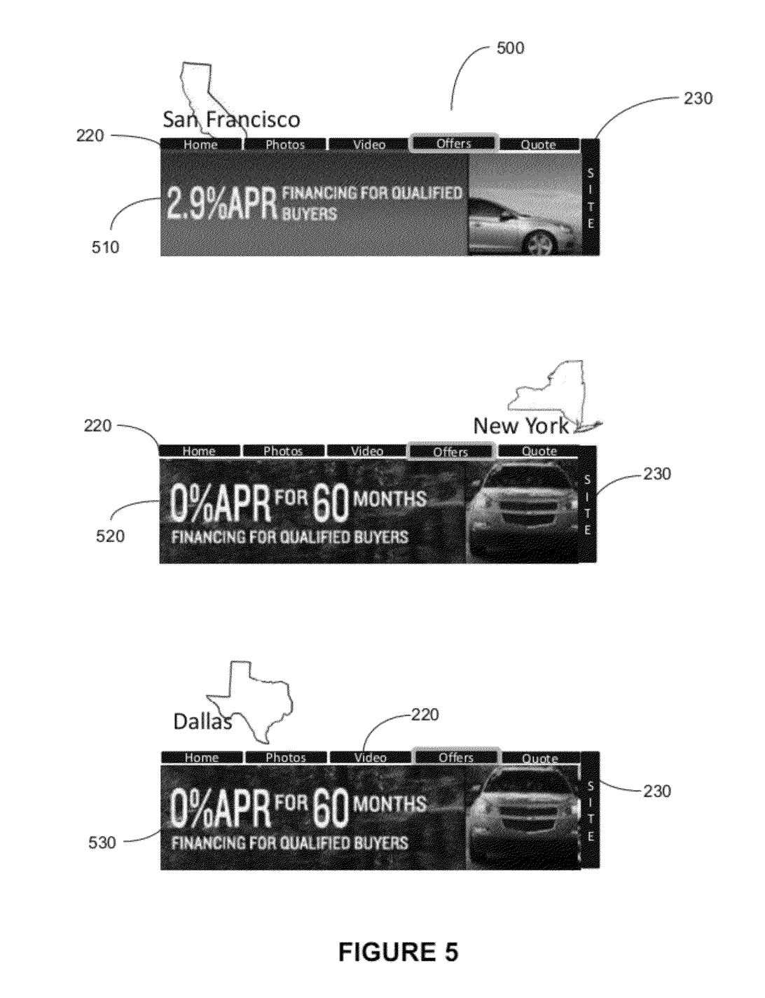

FIG. 5 is a series of screen shots for three locations, i.e. San Francisco, New York, and Dallas, showing a group of dynamic location specific coupons presented within the adsite for the use of the customers or users according to the invention. FIG. 5 shows a screen shot 500 of the offers, 510, 520, and 530 available in each of the three locations.

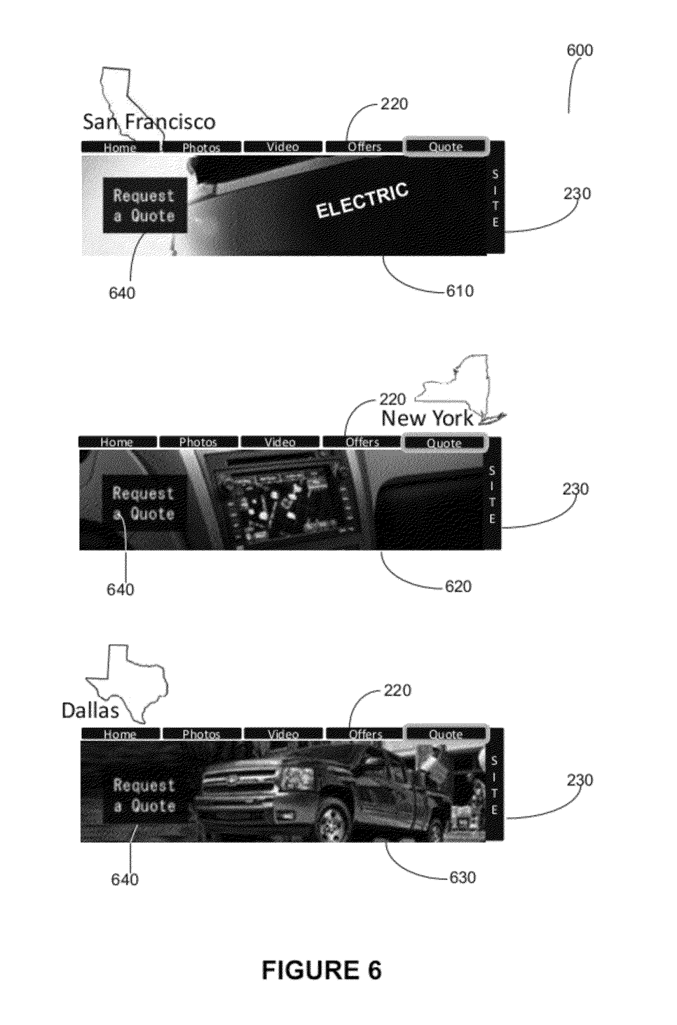

FIG. 6 is a series of screen shots for three locations, i.e. San Francisco, New York, and Dallas, showing a group of dynamic location specific inputs for a request for a quote for a product according to the invention. FIG. 6 shows request for quote adsites 600 for the three locations, San Francisco 610, New York 620, and Dallas 630, respectively. These adsites include external links 640 to the advertiser's location when a user clicks on the hotspot or link on the adsite, thus enabling the user to request and receive a quote for the product from the adsite. These components are used in presenting the adsites at each of the three locations when the customer shows interest either by moving the cursor over the main adsite (hovering) or by clicking on a specific banner unit shown. The processing and location identifying power of the MHDD is used to decide which component sets are to be used to generate the adsites. Additional linked hotspots are used to move to associated linked sites in each of the adsites displays, as discussed above.

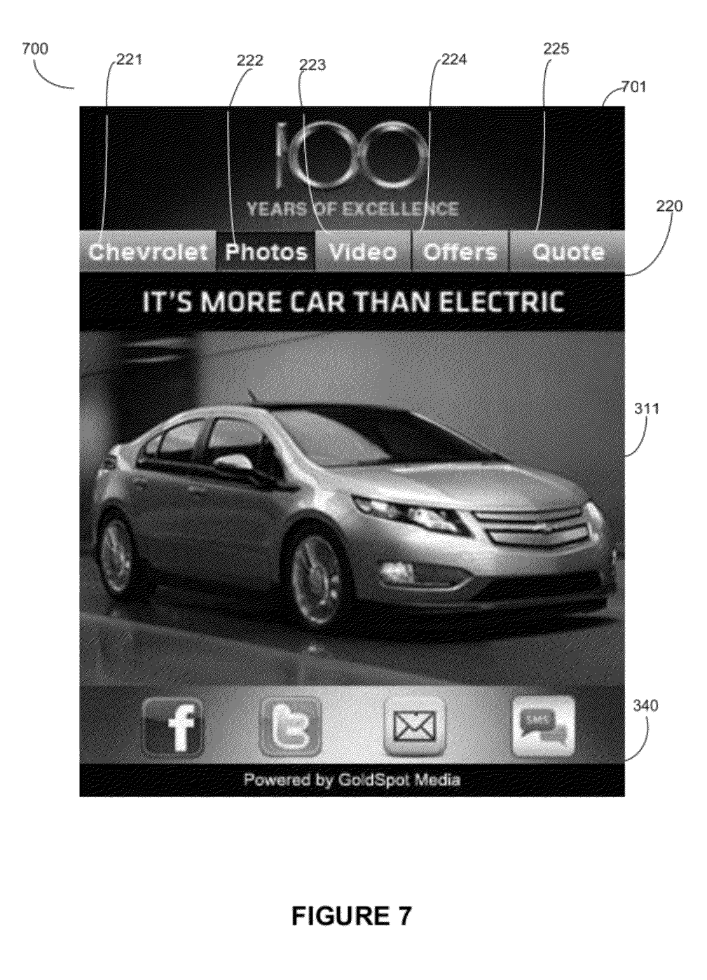

FIG. 7 is a screen shot showing a microsite that is generated and displayed on an MHDD upon user interaction with an adsite shown in the banner area on the MHDD in San Francisco, and in which the microsite can be saved and a link established which can be sent to friends and family, according to the invention. In FIG. 7, an adsite 700 is presented to a user in San Francisco on show of interest, as discussed above. The main campaign ad 701 and a location-specific picture component 311 from the group 310 belonging to San Francisco location is displayed. The location specific component 311 is displayed with a hotspot 340 for moving to the next picture. By choosing a different tag from the navigation bar 220, e.g. the video tag 223, the user is taken to that adsite 410 for San Francisco location to view a Video called Accolade on the product Chevrolet Volt, which is the product offering in San Francisco.

Even though the example in FIG. 7 shows a national ad for a single product, such as a car, with each adsite displaying a different component of the same product offering, it is not meant to be limiting. If a multi-product ad campaign is ongoing, it is possible for each of the faces of the 3D rotator to display an adsite for a different product that is being offered.

The typical mobile ad distribution as microsite, with coupon and promotion distribution services, using adsites is as described below. In an embodiment of the invention, there are two elements to the process. First, user is presented the ad as adsites when they are viewing their favorite content on their mobile device and they are encouraged to save the ad to their email and share with friends over email or other social media.

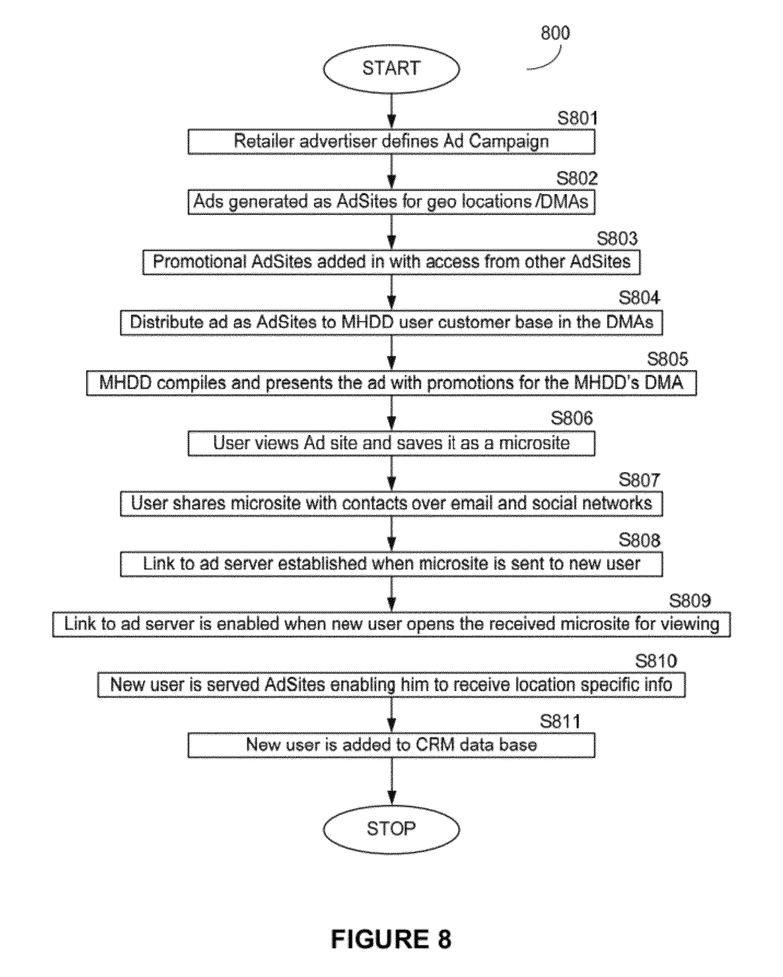

FIG. 8 is a flow diagram showing ad distribution followed by microsite generation and sharing of the microsite with friend and family contacts of the user according to the invention as follows:
Retailer defines the ad campaign (S801).
Ads for the campaign are generated as adsites covering various geo-locations or designated marketing areas (S802).
Mobile coupons or promotions in the form of adsites are included which are accessible from other adsites within the ad (S803).
Distribute adsites of the ad to customer base of MHDD users, of desired geo-locations and DMAs, based on duration of promotion, customer preference, etc. (S804).
User's MHDD, using its processing and location finding capabilities, selects appropriate adsite to compile and presents the user with a single rich mobile ad that outlines one or more products and promotions (S805).
User views and, if the ad is of interest, saves the ad to the user's email as a mobile web site (microsite) (S806).
User shares the microsite via email and/or SMS, and virally as a link via social networks such as Facebook®, Twitter®, and Google+® (S807).
A link to the ad server unit is established when a microsite is sent out to a new user (S808).
When the new user checks the microsite, the link established to the ad server (S809).
The ad server provides the user with dynamic content to configure the appropriate location specific microsite and receive the location specific details when viewing the received microsite of the configured ad on his MHDD (S810).
New user data and preferences are added to CRM data base (S811).

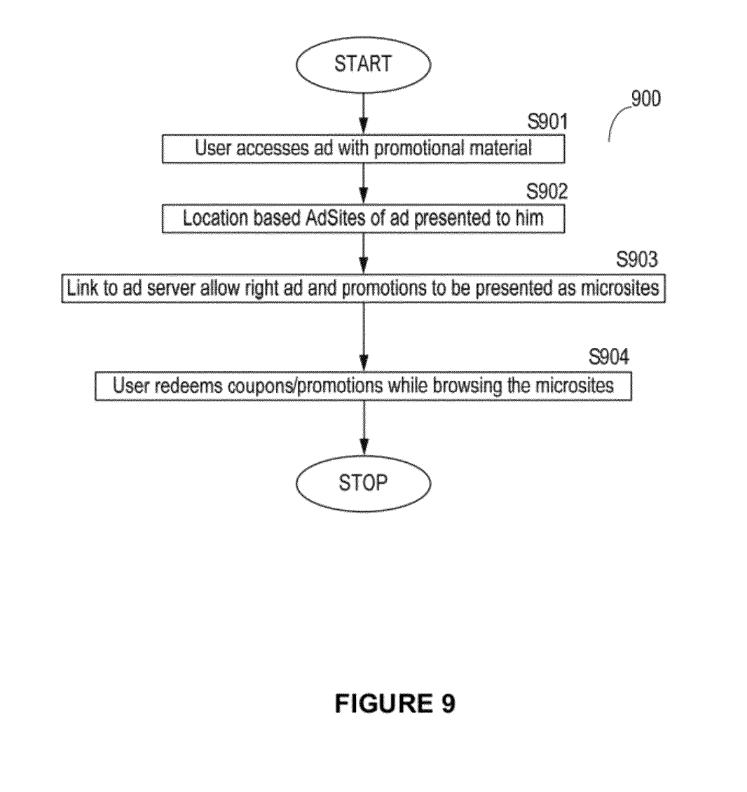

FIG. 9 is a flow diagram showing access, use, and distribution of location based promotional material by the user according to the invention. In FIG. 9, the flow chart 900 shows how the user redeems the promotion while in-store and also distributes promotional material as microsite:
User accesses the promotional ad link on mobile through direct advertising or via email or as mobile web site (microsite) with link received from contacts via e-mail, SMS, Facebook®, or Twitter® (S901).
Ad content is presented to the user as a microsite with adsites that gets generated dynamically, based on the targeting applied to that user while presenting the ad (S902).
The link established to the original adsite ensures location specific and preference characteristics, based on the new user's location and preferences (S903).
User redeems the desired promotions by browsing through the mobile microsite (S904).

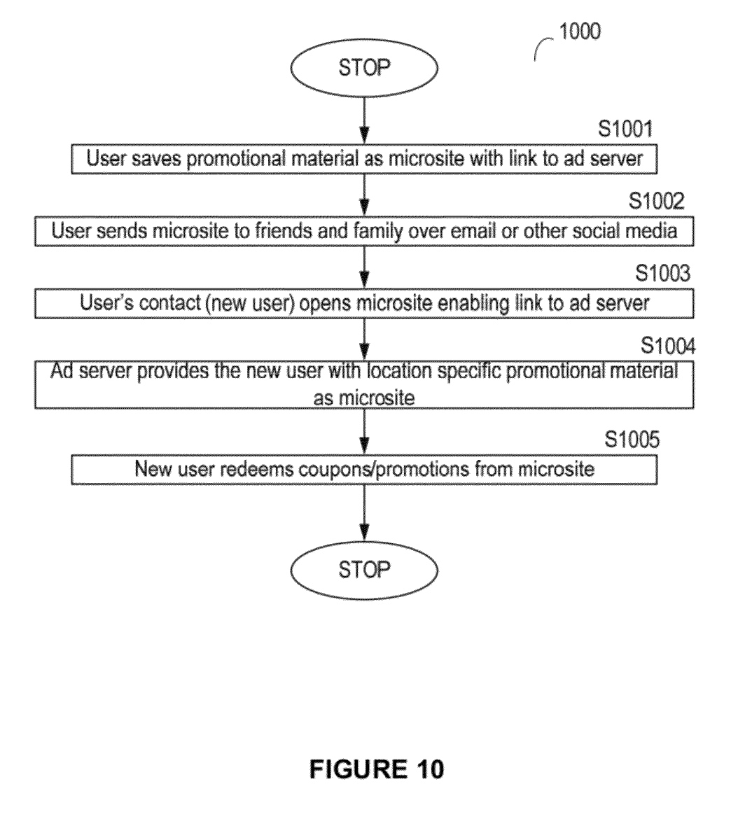

FIG. 10 is a flow diagram showing transfer of microsite and promotional material by the user to friends and family and their access and use of the same during shopping according to the invention. In FIG. 10, the flow chart 1000 shows how a user can send a micro site containing the coupons to friends and family, providing location specific coupons and promotional material for their use when they access the microsite link:
User saves promotional adsites as microsites with links to ad server (S1001).
User sends the microsite to friends and family over email and social media (S1002).
User's friends and family (new users) receive the microsite link and open the microsite enabling the link to the ad server (S1003).
The ad server identifies the location and preferences of the new users and provides the new users with the location specific promotional material and coupons for their use (S1004).
The New users redeem the coupons and other promotional materials from the microsite when shopping (S1005).

Another major advantage provided embodiments of the invention is simplified measurement of campaign impact. As a result of the continuous linkage of the adsite and the microsites distributed with the ad server, it is possible to generate more precise reports and performance matrix for any campaign.

At least four types of exemplary reports are provided. They include:
1. Report of comprehensive ad engagement which comprises real-time national and regional engagement reports. These reports provide real-time information on user interactions measured, for example, as clicks per store, clicks per dealer, or clicks per market zone or ZIP code, etc. These include reports that define the engagement matrix per publisher or ad network. These reports cover at least some reports from the set, including: total customers engaged, customer interaction per day or day part (time period), users engaged per access network, users engaged per device type, users from each carrier, time spent on the ad, viewing time of each adsite, or related microsite. This capability provides the advertiser a very valuable resource to optimize the campaign being run and use the available budget in a way that provides maximum return on investment.
2. Mobile CRM database of users opting-in to save the microsite. This list can be used to augment existing CRM database of the dealer for mobile customers for future use.
3. Mobile CRM database of new customers comprising users opting-in to open the link to the microsite for viewing the virally or otherwise distributed microsite.
4. Campaign effectiveness report of all mobile channels used, such as Facebook®, Twitter®, SMS, Email, downloaded applications, as well as viral sharing of weekly ads, coupons, and promotional material between users.

The value proposition of the service for the advertising retailers is:
Extremely effective mobile alternative to print distribution (ValPak/LocalAd).
Develop CRM database of user opted-in mobile users accessing the promotions.
Spread the message of the ad to high value customers with high probability of interest in the advertised product through direct contacts of the user community with limited additional expense.
Preserve brand value of retailer by not spamming the user through Groupon-like services.
Greater conversion rates and ROI than print.
Promote multiple products within a single rich mobile ad.
Reporting that allows real time tracking of campaign effectiveness.
Easier optimization of resource allocation.
Adding high value users to the CRM database.

### Computer Implementation

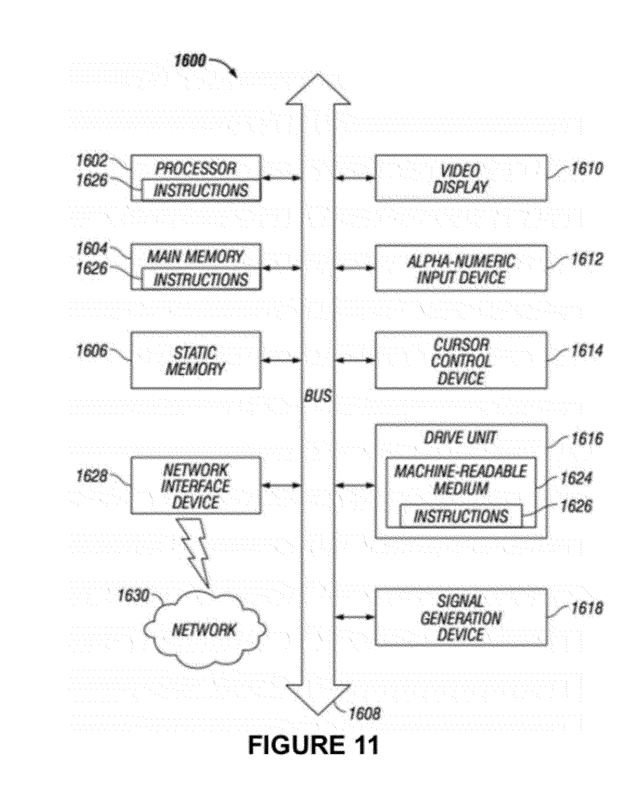

FIG. 11 is a block schematic diagram of a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with complementary metal oxide semiconductor (CMOS), transistor-transistor logic (TTL), very large systems integration (VLSI), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method, comprising:
configuring a mobile handheld display device (MHDD) for communication with an advertisement (ad) server over a wireless link;
configuring said MHDD for identification of its location by use of any of a global positioning system (GPS) and a triangulation method;
said MHDD receiving one or more advertisement sites (adsites) from said ad server over said wireless link, wherein each of said adsites corresponds to at least two location-specific versions of ad campaigns for one or more products;
said MHDD selecting one location-specific version of said received, adsites for display on said MHDD based upon a current location of said MHDD as identified by said MHDD; and
said MHDD displaying a location-specific ad comprising said location-specific adsites on said MHDD display.

2. The method of claim 1, said MHDD displaying a location-specific ad comprising said location-specific adsites on said MHDD display within a banner area thereof.

3. The method of claim 1, said MHDD generating a location-specific mobile advertisement (microsites) upon user interaction with said displayed adsites.

4. The method of claim 3, said MHDD displaying said generated microsite on at least a portion of said MHDD display that is larger than a portion of said MHDD display that is occupied by a banner area.

5. The method of claim 3, said MHDD saving said microsite in a memory of said MHDD.

6. The method of claim 3, further comprising:
configuring said MHDD for communication with other MHDDs over said wireless link.

7. The method of claim 6, said MHDD sending said microsite to one or more third parties over any of email and one or more social networks via said wireless link;
wherein said advertisement is distributed to new users using contacts of existing users.

8. The method of claim 7, wherein said advertisement is distributed to new users as one or more URLs.

9. The method of claim 1, said MHDD using processing and location identifying capability of the MHDD to generate advertisements from said selected location-specific adsites.

10. The method of claim 9, wherein said advertisements are generated based on user location, interest, and interaction.

11. The method of claim 3, wherein said location-specific microsites comprise any of promotions and coupons.

12. A method for advertising campaign management, comprising:
one or more advertisement sites (adsites) delivered from an ad server to one or more mobile handheld display devices (MHDD) over a wireless link, wherein each of said adsites corresponds to at least two location-specific versions of ad campaigns for one or more products;
each said adsite generating a location-specific mobile advertisement (microsites) comprising any of a single ad tag or a generic microsite URL upon user interaction with an adsite displayed on an MHDD;
each adsite sending said microsite as one or more URLs to one or more third parties over any of email and one or more social networks via said wireless link responsive to any of one location-specific version of an adsite being displayed on said MHDD based upon a current location of said MHDD and a location-specific ad comprising said location-specific adsite being displayed on said MHDD display.

13. The method of claim 12, wherein said third parties are targeted for sponsored campaigns over any of SMS, Facebook®, Twitter®, Google+®, and email.

14. The method of claim 12, further comprising:
said adsites sent to said a third party location to dynamically create a user opted-in rich mobile CRM database for future marketing purposes.

15. The method of claim 12, further comprising:
using adsites sent to said a third party location to generate campaign measurements; and
using said campaign measurement to generate aggregated reports across mobile marketing channels.

16. An apparatus, comprising:
a mobile handheld display device (MHDD) configured for communication with an advertisement (ad) server over a wireless link;
said MHDD configured for identification of its location by use of any of a global positioning system (GPS) and a triangulation method;
said MHDD configured for receiving one or more advertisement sites (adsites) from said ad server over said wireless link, wherein each of said adsites corresponds to at least two location-specific versions of ad campaigns for one or more products;
said MHDD configured for selecting one location-specific version of said received, adsites for display on said MHDD based upon a current location of said MHDD as identified by said MHDD; and
said MHDD configured for displaying a location-specific ad comprising said location-specific adsites on said MHDD display.

17. The apparatus of claim 16, said MHDD configured for displaying a location-specific ad comprising said location-specific adsites on said MHDD display within a banner area thereof.

18. The apparatus of claim 16, said MHDD configured for generating a location-specific mobile advertisement (microsites) upon user interaction with said displayed adsites.

19. The apparatus of claim 18, said MHDD configured for displaying said generated microsite on at least a portion of said MHDD display that is larger than a portion of said MHDD display that is occupied by a banner area.

20. The apparatus of claim 18, said MHDD configured for saving said microsite in a memory of said MHDD.

21. The apparatus of claim 18, further comprising:
said MHDD configured for communication with other MHDDs over said wireless link.

22. The apparatus of claim 21, said MHDD configured for sending said microsite to one or more third parties over any of email and one or more social networks via said wireless link;
wherein said advertisement is distributed to new users using contacts of existing users.

23. The apparatus of claim 22, wherein said advertisement is distributed to new users as one or more URLs.

24. The apparatus of claim 16, said MHDD configured for using processing and location identifying capability of the MHDD to generate advertisements from said selected location-specific adsites.
